(19) United States
(12) Patent Application Publication
(10) Pub. No.: US 2025/0312953 A1
(43) Pub. Date: Oct. 9, 2025

(54) REFRIGERATOR FOAMING APPARATUS

(71) Applicant: SAMSUNG ELECTRONICS CO., LTD., Suwon-si (KR)

(72) Inventors: Woochul CHO, Suwon-si (KR); Byungsu KIM, Suwon-si (KR); Youngseok KIM, Suwon-si (KR); Sujin KIM, Suwon-si (KR); Jihoo KIM, Suwon-si (KR); Pocheon KIM, Suwon-si (KR); Hyunwoo BAE, Suwon-si (KR); Minseok CHOI, Suwon-si (KR); Jongwoo HAN, Suwon-si (KR)

(73) Assignee: SAMSUNG ELECTRONICS CO., LTD., Suwon-si (KR)

(21) Appl. No.: 19/246,307

(22) Filed: Jun. 23, 2025

Related U.S. Application Data
(63) Continuation of application No. PCT/KR2023/017632, filed on Nov. 6, 2023.

(30) Foreign Application Priority Data
Jan. 4, 2023 (KR) 10-2023-0001431

(51) Int. Cl. B29C 44/58; B29C 44/12; B29K 105/04; B29L 31/00; F25D 23/06

(52) U.S. Cl. CPC B29C 44/58; B29C 44/1271; F25D 23/065; B29K 2105/04; B29L 2031/7622; F25D 2201/126

(57) ABSTRACT

The refrigerator foaming apparatus for foaming a refrigerator cabinet. The refrigerator foaming apparatus a foaming mold insertable into a side of a storage compartment through an opening of the storage compartment to seat an inner case of the refrigerator cabinet where an edge of the inner case includes a first flange, the foaming mold including a second flange which faces one surface of the first flange while the foaming mold is inserted into the side of the storage compartment. The foaming mold includes a magnet provided to bring the metal plate disposed in the seated inner case into close contact with the other surface of the first flange, and the magnet is provided at the second flange to be disposed to correspond to the metal plate disposed in the first flange while the foaming mold is inserted into the storage compartment.

### CROSS-REFERENCE TO RELATED APPLICATION

This application is a continuation application is a continuation application, under 35U.S.C. § 111 (a), of international application No. PCT/KR2023/017632, filed Nov. 6, 2023, which claims priority under 35 U. S. C. § 119 to Korean Patent Application No. 10-2023-0001431, filed Jan. 4, 2023, the disclosures of which are incorporated herein by reference in their entireties.

### TECHNICAL FIELD

The present disclosure relates to a refrigerator foaming apparatus.

### BACKGROUND ART

A refrigerator foaming apparatus is an apparatus that performs a refrigerator foaming process of injecting a liquid foaming agent between components of a refrigerator and curing the same.

In the case of a foaming process of a refrigerator cabinet, generally, a cabinet combined with a foaming mold is input into a foaming fixture, and left and right sidewalls move to bring the cabinet into close contact. Then, the closely contacted cabinet is elevated together with a lower frame and sequentially combined with a foaming mold mounted on an upper frame.

When the fixing of the cabinet is completed, the foaming agent is injected and foaming proceeds, and the fixed state is continuously maintained until curing is completed.

When curing is completed, a support structure operates to release the fixing of the cabinet, the lower fixture descends, and the cabinet is returned to the direction from which it was input.

In the case of a cabinet combined with a foaming mold, a metal plate for coupling with a heater for preventing dew condensation or a drawer, or the like may be in a state of being attached via double-sided tape.

### DISCLOSURE

### Technical Problem

One aspect of the present disclosure provides a refrigerator foaming apparatus capable of bringing a metal plate into close contact with a cabinet.

One aspect of the present disclosure provides a refrigerator foaming apparatus that prevents a foaming agent from infiltrating between a metal plate and a cabinet.

One aspect of the present disclosure provides a refrigerator foaming apparatus capable of maintaining the performance of a heater.

One aspect of the present disclosure provides a refrigerator foaming apparatus that stably fixes the position of a metal plate.

One aspect of the present disclosure provides a refrigerator foaming apparatus that removes unnecessary materials and processes.

Technical problems to be solved by this document are not limited to the above-mentioned technical problems, and other technical problems, which are not described above, may be clearly understood from the following descriptions by those skilled in the art to which the present disclosure pertains.

### Technical Solution

A refrigerator foaming apparatus for foaming a refrigerator cabinet including, according to the spirit of the present disclosure, includes a foaming mold insertable into a side of a storage compartment to seat an inner case, the foaming mold including a second flange provided to face one surface of the first flange while the foaming mold is inserted into the side of the storage compartment. The foaming mold includes a magnet provided to bring a metal plate of the refrigerator cabinet on another surface of the first flange, to which a heater is attached and which is disposed in the inner case that is seated, into close contact with the other surface of the first flange. The magnet is provided on the second flange so as to be positioned corresponding to the metal plate disposed on the first flange based on the foaming mold being inserted into the storage compartment opening side.

A refrigerator foaming apparatus for foaming a refrigerator cabinet including an inner case in which a first flange is provided along an edge of a storage compartment opening, and a metal plate, to which a heater is attached, is disposed on an other surface of the first flange, according to the spirit of the present disclosure, includes a transfer device for transferring the cabinet of the refrigerator to a standby point. The refrigerator foaming apparatus includes a loading device for coupling the cabinet transferred to the standby point with the foaming mold to form a combination. The refrigerator foaming apparatus includes a fixture that accommodates the combination of the cabinet and the foaming mold. The refrigerator foaming apparatus includes a foaming agent injection device for injecting a foaming agent into the combination accommodated in the fixture. The foaming mold is inserted into the storage compartment opening side and seats the inner case. The foaming mold includes a second flange provided to face one surface of the first flange. The foaming mold includes a magnet provided to bring the metal plate, which is disposed in the seated inner case, into close contact with the other surface of the first flange. The magnet is provided on the second flange so as to be positioned corresponding to the metal plate disposed on the first flange when the foaming mold is inserted into the storage compartment opening side.

A refrigerator foaming apparatus for foaming a refrigerator component including a metal plate, according to the spirit of the present disclosure, includes a foaming mold provided to be in contact with one surface of the component and to seat the component. The foaming mold includes a magnet provided to apply magnetic force to the metal plate of the seated component toward the foaming mold side. The magnet is provided along a portion of an edge side of the foaming mold to bring the component into close contact with the foaming mold side.

### DESCRIPTION OF DRAWINGS

FIG. 1 is a perspective view of a refrigerator according to an embodiment.

FIG. 2 is a side cross-sectional view of the refrigerator according to an embodiment.

FIG. 3 is a view illustrating a state in which some components are disassembled in the refrigerator according to an embodiment.

FIG. 4 is a rear perspective view illustrating a freezer compartment case of the refrigerator according to an embodiment.

FIG. 5 is a view illustrating air being discharged from an upper fan into a clothing care compartment according to an embodiment.

FIG. 6 is a view illustrating an enlarged view of portion A of FIG. 5 according to an embodiment.

FIG. 7 is a view illustrating a refrigerator foaming apparatus according to an embodiment.

FIG. 8 is a view illustrating a foaming mold of the refrigerator foaming apparatus according to an embodiment.

FIG. 9 is a view illustrating an upper fixture provided in a fixture of the refrigerator foaming apparatus according to an embodiment.

FIG. 10 is a view illustrating a supporter provided in a fixture of the refrigerator foaming apparatus according to an embodiment.

FIG. 11 is a view illustrating a lower fixture provided in a fixture of the refrigerator foaming apparatus according to an embodiment.

FIG. 12 is a view illustrating a height adjuster provided in a fixture of the refrigerator foaming apparatus according to an embodiment.

FIG. 13 is a view illustrating a foaming agent injection device of the refrigerator foaming apparatus according to an embodiment.

FIG. 14 is a view illustrating a state in which the foaming agent injection device of the refrigerator foaming apparatus has moved to the fixture according to an embodiment.

FIG. 15 is a view illustrating a state in which a refrigerator cabinet and a foaming mold are separated from each other according to an embodiment.

FIG. 16 is a view illustrating the refrigerator cabinet of FIG. 15 from a different angle according to an embodiment.

FIG. 17 is a view illustrating the foaming mold of FIG. 15 from a different angle according to an embodiment.

FIG. 18 is a side cross-sectional view illustrating a metal plate and a heater in a refrigerator cabinet according to an embodiment.

FIG. 19 is a side cross-sectional view illustrating a magnet in a foaming mold according to an embodiment.

FIG. 20 is a view illustrating a state in which a refrigerator cabinet is seated in a foaming mold according to an embodiment.

FIG. 21 is a view illustrating a state in which a metal plate is in close contact with the other surface of a first flange by a magnet according to an embodiment.

FIG. 22 is a view illustrating a state in which a metal plate is in close contact with the other surface of a first flange by a plurality of magnets according to an embodiment.

FIG. 23 is a view illustrating a refrigerator foaming apparatus for foaming a refrigerator door according to an embodiment.

FIG. 24 is a view illustrating a state in which a door plate (metal plate) is attached by a magnet of the refrigerator foaming apparatus of FIG. 23 according to an embodiment.

FIG. 25 is a view illustrating a state in which a panel is attached to the refrigerator foaming apparatus of FIG. 24 according to an embodiment.

### MODES OF THE INVENTION

The embodiments described in this specification and configurations illustrated in the drawings are merely preferred examples of the present disclosure, and at the time of filing this application, there may be various modifications that may replace the embodiments and drawings of this specification.

In addition, the same reference numerals or symbols presented in each drawing of this specification represent parts or constituent elements that perform substantially the same function.

In addition, the terms used in this specification are used for the purpose of describing embodiments and are not intended to limit and/or restrict the present disclosure. Singular expressions include plural expressions unless clearly described as different meanings in the context. In this specification, it should be understood the terms “comprises,” “comprising,” “includes,” “including,” “containing,” “has,” “having” or other variations thereof are inclusive and therefore specify the presence of stated features, integers, steps, operations, elements, components, or combinations thereof, but do not preclude the presence or addition of one or more other features, integers, steps, operations, elements, components, or combinations thereof.

In addition, terms such as “first,” “second,” and the like, which include ordinal numbers, may be used to describe various constituent elements in this specification, but the constituent elements are not limited by these terms. These terms are used solely for the purpose of distinguishing one constituent element from another constituent element. For example, a first component may be named a second component, and similarly, the second component may also be named the first component, without departing from the scope of the present disclosure. The term “and/or” includes any and all combinations of a plurality of the related and listed items.

Meanwhile, in the following description, the terms “front,” “frontward,” “rear,” “rearward,” “left,” “right,” “up,” “upper,” “down,” “lower,” or the like do not limit the shape or position of each constituent element.

When a constituent element is said to be “connected,” “coupled,” “supported,” or “in contact” with another constituent element, this includes not only cases where the constituent elements are directly connected, coupled, supported, or in contact with each other, but also cases where they are indirectly connected, coupled, supported, or in contact through a third constituent element.

When a constituent element is said to be positioned “on” another constituent element, this includes not only cases where the constituent element is in direct contact with the other constituent element, but also cases where another constituent element exists between the two constituent elements.

In referring to a direction of rotation, a clockwise direction may be expressed as a first direction, and a counterclockwise direction, which is opposite to the first direction, may be expressed as a second direction. Such expressions may be used in describing specific contents for implementing the present disclosure, but the direction of rotation of the components of the present disclosure is not limited by these terms.

Hereinafter, an embodiment will be described in detail with reference to the accompanying drawings.

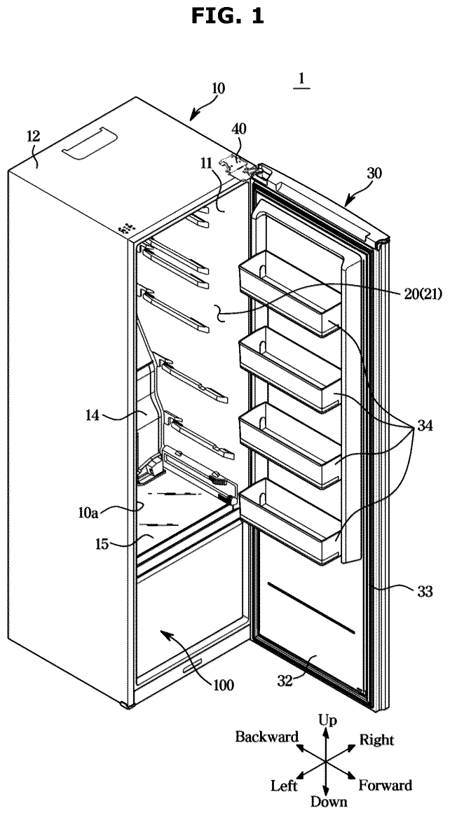

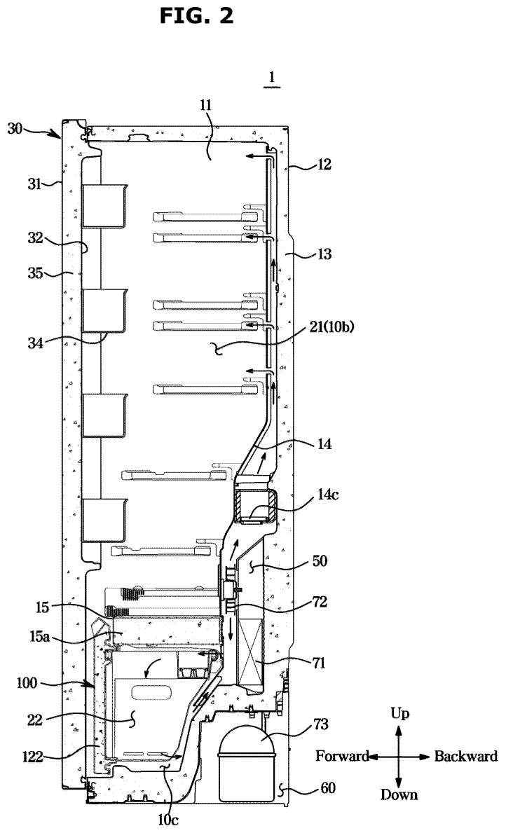

FIG. 1 is a perspective view of a refrigerator according to an embodiment of the present disclosure. FIG. 2 is a side cross-sectional view of the refrigerator according to an embodiment of the present disclosure.

With reference to FIGS. 1 and 2, a refrigerator 1 may include a main body 10, a storage compartment 20 provided inside the main body 10, a door 30 that opens and closes the storage compartment 20, and a cooling system for supplying cold air to the storage compartment 20.

The main body 10 may be formed such that a front surface thereof is opened so that a user may load and unload food in and from the storage compartment 20. That is, the main body 10 may include a storage compartment opening 10a formed on a front surface of the main body 10. The storage compartment opening 10a of the main body 10 may be opened and closed by the door 30.

The main body 10 may include an inner case 11 that forms the storage compartment 20, an outer case 12 that forms the exterior of the refrigerator 1, and a main body insulation 13 provided between the inner case 11 and the outer case 12. The inner case 11 and the outer case 12 may be described by being referred to as a cabinet C of the refrigerator, and the same shall apply hereinafter.

The outer case 12 may be formed to have a shape of a box having a front surface that is substantially open. The outer case 12 may form an upper surface, a lower surface, left and right side surfaces, and a rear surface of the refrigerator 1.

The outer case 12 may be configured to include a metallic material. For example, the outer case 12 may be manufactured by processing a steel plate material.

The inner case 11 may have a front surface that is open. The inner case 11 may be provided with the storage compartment 20 therein and may be provided on an inner side of the outer case 12. An inner wall of the inner case 11 may form an inner wall of the storage compartment 20.

The inner case 11 may be configured to include a plastic material. For example, the inner case 11 may be manufactured by a vacuum forming process. For example, the inner case 11 may be manufactured by an injection molding process.

The main body insulation 13 may be provided so that the outer case 12 and the inner case 11 are thermally insulated from each other. The main body insulation 13 may couple the inner case 11 and the outer case 12 to each other by being foamed between the inner case 11 and the outer case 12. The main body insulation 13 may prevent heat exchange occurring between the interior of the storage compartment 20 and the exterior of the main body 10, thereby improving cooling efficiency inside the storage compartment 20.

As the main body insulation 13, urethane foam insulation, expanded polystyrene (EPS) insulation, vacuum insulation panel, or the like may be used. However, the main body insulation 13 is not limited thereto and may be configured to include various materials.

An internal space of the main body 10 may include a first internal space 10b and a second internal space 10c. The second internal space 10c may be disposed below the first internal space 10b. For example, the first internal space 10b may be formed in an upper portion inside the main body 10, and the second internal space 10c may be formed in a lower portion inside the main body 10.

The first internal space 10b and the second internal space 10c may be formed inside the inner case 11. In other words, the first internal space 10b may be defined as referring to a portion of the internal space formed inside the inner case 11, and the second internal space 10c may be defined as referring to another portion of the internal space formed inside the inner case 11, provided below the first internal space 10b.

Cold air generated by a cold air supply device, which will be described below, may be supplied to each of the first internal space 10b and the second internal space 10c. The first internal space 10b and the second internal space 10c may be provided to communicate with a cooling chamber 50, respectively. Cold air generated by the cold air supply device may flow from the cooling chamber 50 into the first internal space 10b and the second internal space 10c.

A storage compartment 20 may be formed inside the main body 10. The storage compartment 20 may include a refrigerating compartment 21 maintained at approximately 0 to 5 degrees Celsius to preserve food by refrigerating, and a freezing compartment 22 maintained at approximately −30 to 0 degrees Celsius to preserve food by freezing.

The refrigerating compartment 21 may be provided in the first internal space 10b of the main body 10. The refrigerating compartment 21 may be provided in an upper portion of an internal space of the main body 10. The refrigerating compartment 21 may be provided above the second internal space 10c.

Cold air introduced into the first internal space 10b from the cooling chamber 50 may be introduced into the refrigerating compartment 21, and the first internal space 10b may be maintained at a temperature suitable for preserving food by refrigerating.

For example, the refrigerating compartment 21 may be a space that substantially corresponds to the first internal space 10b of the main body 10. The first internal space 10b may refer to a space formed inside the main body 10 itself, and the refrigerating compartment 21 may refer to a portion of the storage compartment 20 for storing food, and thus the definitions thereof may be distinguished.

A shelf (not illustrated) on which food can be placed and a storage container (not illustrated) for storing food may be provided in the refrigerating compartment 21.

The freezing compartment 22 may be provided to be inserted into or withdrawn from the second internal space 10c of the main body 10. More specifically, the freezing compartment 22 may be provided inside a freezing compartment case 100, which will be described below, and the freezing compartment case 100 may be provided to be inserted into or withdrawn from the second internal space 10c. When the freezing compartment case 100 is inserted into the second internal space 10c, the freezing compartment 22 may be inserted and may be closed. When the freezing compartment case 100 is withdrawn from the second internal space 10c, the freezing compartment 22 may be withdrawn and may be opened.

In other words, the freezing compartment 22 may be positioned inside the main body 10 when the freezing compartment case 100 is inserted, and conversely, at least a portion of the freezing compartment 22 may be positioned outside the main body 10 when the freezing compartment case 100 is withdrawn. However, the present disclosure is not limited thereto, and depending on the size of the freezing compartment case 100 or a length by which the freezing compartment case 100 can be withdrawn, the freezing compartment 22 may also be positioned inside the main body 10 even when the freezing compartment case 100 is withdrawn.

The freezing compartment 22 is a space provided inside the freezing compartment case 100, and is a portion of the storage compartment 20 in which food can be stored and preserved by freezing. Although the freezing compartment 22 may share a portion of space with the second internal space 10c, the freezing compartment 22 is provided to be insertable into or withdrawable from the main body 10 together with the freezing compartment case 100, and because the space in which food is directly stored is the freezing compartment 22 provided inside the freezing compartment case 100, the freezing compartment 22 may be distinguished from the second internal space 10c.

The freezing compartment 22 may be positioned in the second internal space 10c when the freezing compartment case 100 is in an inserted position with respect to the second internal space 10c. Cold air introduced from the cooling chamber 50 into the second internal space 10c may be introduced into the freezing compartment 22, and the second internal space 10c may be maintained at a temperature suitable for preserving food by freezing.

As described above, in the refrigerator 1 according to an embodiment of the present disclosure, the refrigerating compartment 21 may be provided in the first internal space 10b, and the freezing compartment 22 may be provided in the second internal space 10c that is disposed below the first internal space 10b. In other words, the refrigerator 1 according to an embodiment of the present disclosure may be a bottom mounted freezer (BMF) type refrigerator in which the refrigerating compartment 21 is formed in an upper side and the freezing compartment 22 is formed in a lower side.

The main body 10 may include a partition wall 15 that partitions the first internal space 10b and the second internal space 10c. The partition wall 15 may be provided between the first internal space 10b and the second internal space 10c. More specifically, the main body 10 may include the partition wall 15 that partitions the first internal space 10b and the second internal space 10c in a vertical direction.

The partition wall 15 may partition the first internal space 10b and the second internal space 10c in a direction horizontal to the ground. The partition wall 15 may extend in a direction horizontal to the ground.

An upper surface of the partition wall 15 may face the first internal space 10b. The upper surface of the partition wall 15 may form a lower surface of the first internal space 10b. The upper surface of the partition wall 15 may form a lower surface of the refrigerating compartment 21.

A lower surface of the partition wall 15 may face the second internal space 10c. The lower surface of the partition wall 15 may form a lower surface of the second internal space 10c. The lower surface of the partition wall 15 may cover an upper side of the freezing compartment 22 when the freezing compartment case 100 is inserted into the second internal space 10c. The lower surface of the partition wall 15 may form an upper surface of the freezing compartment 22 when the freezing compartment case 100 is inserted into the second internal space 10c.

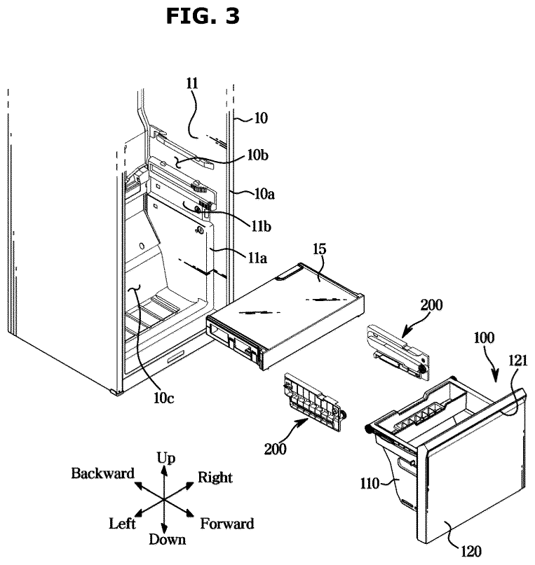

The partition wall 15 may be disposed inside the inner case 11. The partition wall 15 may be coupled to an inner wall of the inner case 11. Specifically, the inner case 11 may include a partition wall coupling portion 11b formed on an inner wall of the inner case 11 (see FIG. 3), and the partition wall 15 may be coupled to the partition wall coupling portion 11b. For example, the partition wall coupling portion 11b may be formed to have a shape of a groove recessed into the inner wall of the inner case 11. The partition wall 15 may be inserted into the groove of the partition wall coupling portion 11b and coupled thereto.

The partition wall coupling portion 11b may be formed on a left side surface or a right side surface of the inner case 11 with reference to FIG. 1.

However, the present disclosure is not limited thereto, and the partition wall 15 may be configured in various ways to be disposed inside the inner case 11. For example, the partition wall 15 may be bonded using an adhesive, etc. or coupled to the inner case 11 using a fastening member such as a screw. For example, the partition wall 15 may be integrally formed with the inner case 11.

As described above, the refrigerating compartment 21 may be provided in the first internal space 10b, and the freezing compartment 22 may be provided in the second internal space 10c. Therefore, the first internal space 10b and the second internal space 10c need to be maintained at different temperatures.

The partition wall 15 may partition the first internal space 10b and the second internal space 10c such that they are thermally insulated from each other. The partition wall 15 may be provided such that the refrigerating compartment 21 and the freezing compartment 22 are thermally insulated from each other when the freezing compartment case 100 is inserted.

For example, the partition wall 15 may include a partition wall insulation 15a provided inside the partition wall 15. The partition wall insulation 15a may be formed by being foamed between an upper surface and a lower surface of the partition wall 15.

The partition wall insulation 15a may be provided to prevent heat exchange occurring between the first internal space 10b and the second internal space 10c, thereby allowing the refrigerating compartment 21 and the freezing compartment 22 to be maintained at different temperatures.

As the partition wall insulation 15a, urethane foam insulation, expanded polystyrene (EPS) insulation, vacuum insulation panel, or the like may be used. However, the present disclosure is not limited thereto, and the partition wall insulation 15a may be configured to include various materials.

For example, the partition wall insulation 15a may be composed of the same insulation material as the main body insulation 13. Alternatively, for example, the partition wall insulation 15a may be composed of an insulation material different from that of the main body insulation 13.

For example, the partition wall 15 may be manufactured in a manner in which the partition wall insulation 15a is first foamed inside the partition wall 15 in a manufacturing stage, and then the partition wall 15 is coupled to the inner case 11. Alternatively, for example, the partition wall 15 may be manufactured in a manner in which the partition wall 15 is first coupled to the inner case 11 in a state before the partition wall insulation 15a is foamed, and then the partition wall insulation 15a is foamed simultaneously with the main body insulation 13. However, the present disclosure is not limited thereto, and the partition wall 15 may be manufactured in various ways.

The refrigerator 1 may include a cooling system that is provided to generate cold air using a cooling cycle and supply the generated cold air to the first internal space 10b and the second internal space 10c.

The cooling system may generate cold air using latent heat of evaporation of a refrigerant in the cooling cycle. The cooling system may be configured to include a compressor 73, a condenser (not illustrated), an expansion valve (not illustrated), an evaporator 71, and a blower fan 72.

The cooling chamber 50 and a machine room 60 may be provided in the main body 10 so that the cooling system is disposed therein. For example, the cooling chamber 50 may include components such as the evaporator 71 that generates cold air, and the blower fan 72 that is provided to allow the cold air generated by the evaporator 71 to flow. The machine room 60 may include components such as the compressor 73 and the condenser.

The cooling chamber 50 may be disposed at the rear of the first internal space 10b. The cooling chamber 50 may be disposed at the rear of the second internal space 10c.

The machine room 60 may be disposed at the rear of the first internal space 10b. The machine room 60 may be disposed at the rear of the second internal space 10c.

The components of the refrigerator 1 constituting the cooling system may have a weight that is not relatively small. Accordingly, the cooling chamber 50 and the machine room 60 may be provided at a lower portion of the main body 10. However, the present disclosure is not limited thereto, and the cooling chamber 50 and the machine room 60 may be disposed in various manners, and the components constituting the cooling system may be disposed in various manners corresponding to the positions of the cooling chamber 50 and the machine room 60.

Because cold air is generated by the evaporator 71 in the cooling chamber 50, the cooling chamber 50 may maintain a relatively low temperature state. In contrast, because heat is generated by the compressor 73 and the condenser in the machine room 60, the machine room 60 may maintain a relatively high temperature state. Therefore, the cooling chamber 50 and the machine room 60 may be formed in separate spaces and may be thermally insulated from each other. For example, the main body insulation 13 may be foamed between the cooling chamber 50 and the machine room 60.

As illustrated in FIG. 2, the evaporator 71 provided in the cooling chamber 50 may generate cold air by evaporating a refrigerant, and the cold air generated by the evaporator 71 may flow by the blower fan 72. A portion of the cold air flowing by the blower fan 72 may be supplied to the first internal space 10b, and another portion of the cold air flowing by the blower fan 72 may be supplied to the second internal space 10c. In other words, the evaporator 71 may generate cold air in the cooling chamber 50, and the cold air generated by the evaporator 71 may flow from the cooling chamber 50 to the storage compartment 20 by the blower fan 72 provided in the cooling chamber 50. The cooling chamber 50 may be provided to communicate with the first internal space 10b and the second internal space 10c, respectively.

In other words, as illustrated in FIG. 2, the refrigerator 1 according to an embodiment of the present disclosure may be an indirect cooling type refrigerator. Hereinafter, for the convenience of description, it is assumed that the refrigerator 1 according to an embodiment of the present disclosure is an indirect cooling type refrigerator, but the technical spirit of the present disclosure is not limited thereto and may also be applied to a direct cooling type refrigerator.

The evaporator 71, the blower fan 72, and the like disposed in the cooling chamber 50, which generate cold air and supply the cold air to the storage compartment 20, may be referred to as a cold air supply device.

The main body 10 may include a cold air supply duct 14. The cold air supply duct 14 may form a flow path through which cold air generated by the cold air supply device flows from the cooling chamber 50 to the first internal space 10b or the second internal space 10c. The first internal space 10b and the second internal space 10c may be provided to communicate with the cold air supply duct 14, respectively.

The cold air supply duct 14 may be formed inside the inner case 11. The cold air supply duct 14 may be formed at a rear portion of the inner case 11. More specifically, the cold air supply duct 14 may be provided at the rear of the storage compartment 20.

For example, only one evaporator 71 may be provided in the cooling chamber 50. The blower fan 72 may be provided to allow cold air generated by the single evaporator 71 to flow to each of the first internal space 10b and the second internal space 10c. In this case, the cold air generated by the single evaporator 71 may have a temperature within a predetermined range. Therefore, in order to maintain different temperatures in the first internal space 10b and the second internal space 10c, amounts of the cold air introduced into the first internal space 10b and the second internal space 10c may be formed to be different from each other. For example, a damper 14c may be provided in the cold air supply duct 14 to adjust an amount of cold air directed toward the first internal space 10b. The damper 14c may be provided to open and close a flow path of cold air directed from the cooling chamber 50 to the first internal space 10b. The refrigerating compartment 21 may be provided with a refrigerating compartment temperature sensor (not illustrated) provided to measure a temperature of the refrigerating compartment 21, and a processor (not illustrated) of the refrigerator 1 may receive an output value of the refrigerating compartment temperature sensor and control an opening and closing of the damper 14c.

However, the present disclosure is not limited thereto, and configurations for maintaining different temperatures in the first internal space 10b and the second internal space 10c may be variously provided. For example, two or more evaporators (not illustrated) may be provided in the cooling chamber 50. At least one evaporator may be provided to generate cold air supplied to the first internal space 10b, and at least another evaporator may be provided to generate cold air supplied to the second internal space 10c. Corresponding to each of the evaporators, two or more blower fans (not illustrated) may be provided in the cooling chamber 50. Here, the evaporator and blower fan for supplying cold air to the first internal space 10b, and the evaporator and blower fan for supplying cold air to the second internal space 10c, may be disposed in mutually partitioned spaces within the cooling chamber 50.

The door 30 may be provided to open and close the main body 10. The door 30 may be rotatably coupled to the main body 10. More specifically, the door 30 may be rotatably coupled to the main body 10 by a hinge 40 connected to each of the door 30 and the main body 10. The door 30 may be rotatably coupled to the outer case 12.

An outer surface 31 of the door 30 may form a portion of the exterior of the refrigerator 1. In a closed position of the door 30, the outer surface 31 of the door 30 may form a front surface of the door 30.

An inner surface 32 of the door 30 may be formed on a side opposite to the outer surface 31 of the door 30. In the closed position of the door 30, the inner surface 32 of the door 30 may form a rear surface of the door 30. In the closed position of the door 30, the inner surface 32 of the door 30 may be provided to face an inside of the main body 10. In the closed position of the door 30, the inner surface 32 of the door 30 may be provided to cover the front of the first internal space 10b and the second internal space 10c.

A foaming space may be formed between the outer surface 31 and the inner surface 32 of the door 30, and a door insulation 35 may be foamed therein. The door insulation 35 may prevent heat exchange occurring between the outer surface 31 and the inner surface 32 of the door 30. The door insulation 35 may improve thermal insulation performance between the inside of the storage compartment 20 and the outside of the door 30.

As the door insulation 35, urethane foam insulation, expanded polystyrene (EPS) insulation, vacuum insulation panel, or the like may be used. However, the present disclosure is not limited thereto, and the door insulation 35 may be configured to include various materials.

For example, the door insulation 35 may be composed of the same insulation material as the main body insulation 13 or the partition wall insulation 15a. Alternatively, for example, the door insulation 35 may be composed of an insulation material different from the main body insulation 13 or the partition wall insulation 15a.

A door gasket 33 may be provided on the inner surface 32 of the door 30 to seal a gap between the door 30 and the main body 10 to prevent cold air in the storage compartment 20 from leaking. The door gasket 33 may be provided along a periphery of the inner surface 32 of the door 30. The door gasket 33 may be disposed to be aligned with the storage compartment opening 10a of the main body 10 when the door 30 is closed. The door gasket 33 may be configured to include an elastic material such as rubber.

A door shelf 34 for storing food may be provided on the inner surface 32 of the door 30.

The door 30 may be provided as a single door, and may be rotatably coupled to the main body 10 to open and close the main body 10. In other words, the single door 30 may be provided to open and close an entire internal space of the main body 10.

The door 30 may close the first internal space 10b when closing the storage compartment opening 10a of the main body 10. The door 30 may cover the front of the first internal space 10b when closing the storage compartment opening 10a of the main body 10.

The door 30 may cover the front of the freezing compartment case 100, which will be described below, when closing the storage compartment opening 10a of the main body 10. In other words, when the door 30 is closed, the front of the freezing compartment case 100 may be closed by the door 30 while the freezing compartment case 100 is in an inserted position in the second internal space 10c. The door 30 may not directly close the second internal space 10c when closing the storage compartment opening 10a of the main body 10, but may cover the front of the freezing compartment case 100 that has closed the second internal space 10c, thereby covering the front of the second internal space 10c.

The door 30 may cover the front of the partition wall 15 when closing the storage compartment opening 10a of the main body 10. That is, the partition wall 15 may be entirely disposed inside the main body 10, and in a state in which the storage compartment opening 10a of the main body 10 is closed, the partition wall 15 may be covered by the door 30 and may not be exposed externally.

The above-described configuration of the refrigerator 1, described with reference to FIGS. 1 and 2, is merely an example for describing the refrigerator according to the spirit of the present disclosure, and the spirit of the present disclosure is not limited thereto. A refrigerator according to the spirit of the present disclosure may be provided to include various configurations to perform a function of supplying cold air to a refrigerating compartment and a freezing compartment for storing food.

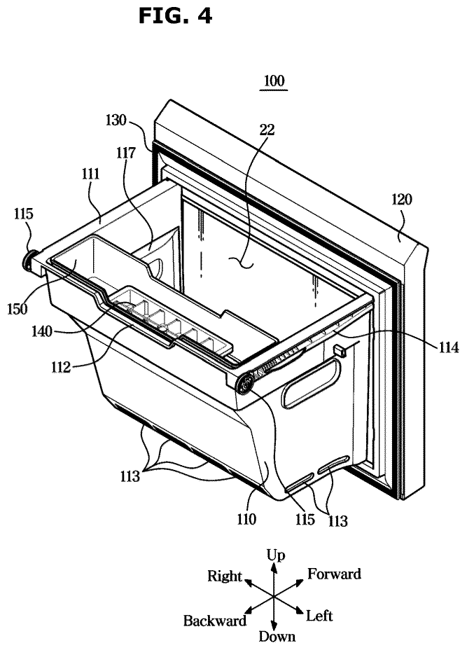

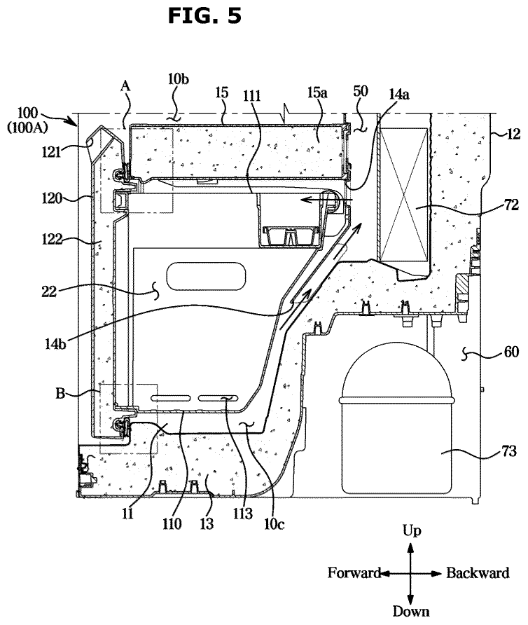

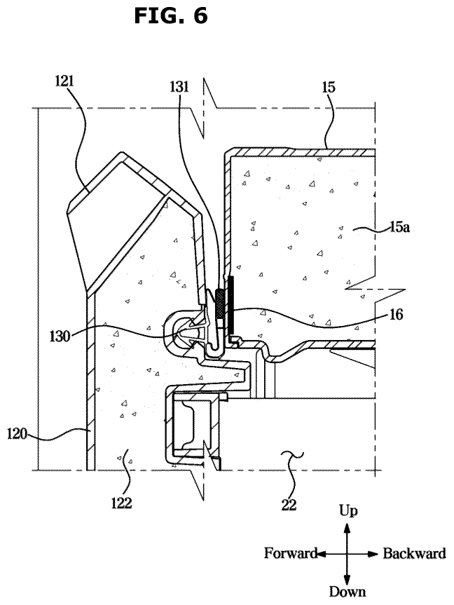

FIG. 3 is a view illustrating a state in which some components are disassembled in the refrigerator according to an embodiment of the present disclosure. FIG. 4 is a rear perspective view illustrating a freezing compartment case of the refrigerator according to an embodiment of the present disclosure. FIG. 5 is an enlarged cross-sectional view illustrating a partial configuration of a refrigerator according to an embodiment of the present disclosure. FIG. 6 is a view illustrating an enlarged portion A of FIG. 5.

With reference to FIGS. 3 to 6, the refrigerator 1 may include the freezing compartment case 100 in which the freezing compartment 22 is provided. The freezing compartment case 100 may be provided to open and close the freezing compartment 22. The freezing compartment 22 may be defined as a space formed inside the freezing compartment case 100.

The freezing compartment case 100 may be provided inside the main body 10. More specifically, the freezing compartment case 100 may be provided inside the inner case 11.

The freezing compartment case 100 may be provided in the second internal space 10c of the main body 10. The freezing compartment case 100 may be provided at a lower portion of the main body 10. Correspondingly, the freezing compartment 22 may also be provided in the second internal space 10c of the main body 10. The freezing compartment 22 may be provided at the lower portion of the main body 10.

The freezing compartment case 100 may be provided to be inserted into or withdrawn from the second internal space 10c. The freezing compartment 22 may be provided to be inserted into or withdrawn from the second internal space 10c together with the freezing compartment case 100. When the freezing compartment case 100 is withdrawn from the second internal space 10c, the freezing compartment 22 may be withdrawn from the second internal space 10c. When the freezing compartment case 100 is inserted into the second internal space 10c, the freezing compartment 22 may be inserted into the second internal space 10c.

The freezing compartment case 100 may be provided to be slidingly moveable with respect to the second internal space 10c.

The refrigerator 1 may further include a rail 200 for supporting the freezing compartment case 100 so that the freezing compartment case 100 is slidingly moveable into the second internal space 10c.

The rail 200 may be provided in the second internal space 10c. The freezing compartment case 100 may be provided to be slidingly moveable along the rail 200, and may be provided to be insertable into or withdrawable from the second internal space 10c.

The rail 200 may be provided on an inner wall of the inner case 11. For example, the rail 200 may be provided on left inner wall and right inner wall of the inner case 11 with reference to FIG. 3, respectively.

For example, the rail 200 may be mounted to the inner case 11. The rail 200 may be mounted to an inner wall of the second internal space 10c. The rail 200 may be mounted to left inner wall and right inner wall of the inner case 11 with reference to FIG. 3, respectively.

Alternatively, for example, the rail 200 may be integrally formed with an inner wall of the inner case 11, without being separately formed and mounted to the inner case 11.

The freezing compartment case 100 may cover the front of the second internal space 10c. The freezing compartment case 100 may be provided to be insertable into or withdrawable from the second internal space 10c, in a state of covering the front of the second internal space 10c.

The freezing compartment case 100 may be inserted into the second internal space 10c to prevent cold air in the second internal space 10c from leaking to the outside.

The freezing compartment case 100 may include a freezing compartment opening 111 that opens the freezing compartment 22. The freezing compartment opening 111 may be formed at an upper portion of the freezing compartment case 100. The freezing compartment opening 111 may be formed to open the freezing compartment 22 in an up-down direction.

When the door 30 closes the storage compartment opening 10a of the main body 10, the front of the freezing compartment case 100 may be covered by the door 30. The door 30 may be provided to cover a front surface portion 120 of the freezing compartment case 100, which will be described below, when the door 30 is closed.

In other words, when the door 30 closes the first internal space 10b, the door 30 may cover the front of the freezing compartment case 100.

In addition, when the door 30 closes the storage compartment opening 10a of the main body 10, the door 30 may cover the front of the partition wall 15. The door 30 may simultaneously cover the front of both the partition wall 15 and the freezing compartment case 100 when the first internal space 10b is closed.

With such a configuration, when the door 30 is closed, an exterior of the refrigerator 1 may be formed by the outer case 12 and the door 30. Specifically, a front exterior of the refrigerator 1 may be primarily formed by the outer surface 31 of the door 30. When the door 30 is closed, the partition wall 15 and the freezing compartment case 100 may be positioned inside the main body 10, covered by the door 30, and may not form the exterior of the refrigerator 1.

In other words, the refrigerator 1 according to an embodiment of the present disclosure may have a front exterior formed by the single door 30 that opens and closes the storage compartment opening 10a of the main body 10. The refrigerator 1 that is opened and closed by the single door 30 may provide an exterior that gives a different aesthetic impression to a user, compared to the refrigerator 1 that is opened and closed by a plurality of doors 30.

In a type of refrigerator 1 in which the storage compartment 20 is opened and closed by the single door 30, the refrigerating compartment 21 and the freezing compartment 22 may be partitioned from each other as the freezing compartment 22 is provided inside the freezing compartment case 100.

The freezing compartment case 100 may be provided to be insertable into or withdrawable from the second internal space 10c positioned at a lower portion of the main body 10, so that a user may easily access the freezing compartment 22.

The freezing compartment case 100 may include a case body 110 in which the freezing compartment 22 is provided, and the front surface portion 120 forming a front surface of the freezing compartment case 100.

The case body 110 may have a shape of a basket substantially formed to enable food to be stored therein, as illustrated in FIG. 3 and related figures. The shape of the case body 110 is not limited to the shape illustrated in FIG. 3, and may be formed to have various shapes in which the freezing compartment 22 may be provided.

The case body 110 may include the above-described freezing compartment opening 111. The freezing compartment opening 111 may be provided at an upper portion of the case body 110. That is, the case body 110 may include a shape that is open at an upper portion thereof.

The front surface portion 120 may be provided in front of the case body 110. The front surface portion 120 may be provided in front of the freezing compartment 22. The front surface portion 120 may cover the front of the freezing compartment 22.

The front surface portion 120 may be formed to include a shape of a substantially flat plate. However, the present disclosure is not limited thereto, and the front surface portion 120 may be formed to have various shapes.

The front surface portion 120 may include a grip portion 121 formed to allow a user to grip.

The inner case 11 may include a first flange 11a provided to support the front surface portion 120 in an insertion position 100A. When the freezing compartment case 100 is in the insertion position 100A, the front surface portion 120 may be positioned at a position most adjacent to the first flange 11a.

The first flange 11a may be provided adjacent to a front portion of the second internal space 10c. The first flange 11a may be provided along an edge of the storage compartment opening 10a. More specifically, the first flange 11a may be formed along a periphery of an opening opened in a forward-backward direction at the front portion of the second internal space 10c.

The front surface portion 120 may be provided to cover one surface of the first flange 11a.

The freezing compartment case 100 may include a case insulation 122. The case insulation 122 may be provided so that the first internal space 10b and the freezing compartment 22 are thermally insulated from each other at the insertion position 100A.

The case insulation 122 may be provided at the front of the freezing compartment 22. More specifically, the case insulation 122 may be provided in the front surface portion 120 of the freezing compartment case 100.

The case insulation 122 may prevent heat exchange occurring between the first internal space 10b and the freezing compartment 22. In addition, the case insulation 122 may prevent heat exchange occurring between the first internal space 10b and the second internal space 10c.

For example, the case insulation 122 may be foamed inside the front surface portion 120. A foaming space may be formed between a front surface and a rear surface of the front surface portion 120, and the case insulation 122 may be foamed therein.

As the case insulation 122, urethane foam insulation, expanded polystyrene (EPS) insulation, vacuum insulation panel, or the like may be used. However, the present disclosure is not limited thereto, and the case insulation 122 may be configured to include various materials.

For example, the case insulation 122 may be composed of the same insulation material as the main body insulation 13, the partition wall insulation 15a, or the door insulation 35. Alternatively, for example, the case insulation 122 may be composed of an insulation material different from the main body insulation 13, the partition wall insulation 15a, or the door insulation 35.

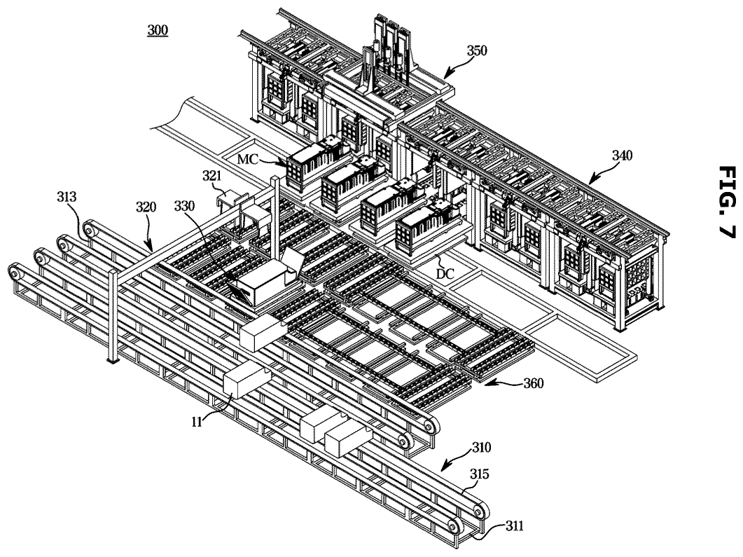

The main body insulation 13 may be foamed between the inner case 11 and the outer case 12. The main body insulation 13 may be foamed in a refrigerator cabinet 11 or 12 through a refrigerator foaming apparatus 300 (see FIG. 7). A specific process in which the main body insulation 13 is foamed into the refrigerator cabinet 11 or 12 by the refrigerator foaming apparatus 300 will be described below.

The freezing compartment case 100 may further include a sealing member 130 provided to seal between the front surface portion 120 and the partition wall 15, or between the front surface portion 120 and the inner case 11.

The sealing member 130 may be provided on a rear surface of the front surface portion 120. The sealing member 130 may be provided along a periphery of the rear surface of the front surface portion 120. The sealing member 130 may be formed to have a substantially closed-loop shape.

The rear surface of the front surface portion 120 may face the inner case 11. More specifically, the rear surface of the front surface portion 120 may face the first flange 11a of the inner case 11. The sealing member 130 may be provided to seal a gap between the rear surface of the front surface portion 120 and the first flange 11a.

The rear surface of the front surface portion 120 may face the partition wall 15. The sealing member 130 may be provided to seal a gap between the rear surface of the front surface portion 120 and the partition wall 15.

The sealing member 130 may be configured to include an elastic material such as rubber. However, the present disclosure is not limited thereto, and the sealing member 130 may be configured to include various materials.

The sealing member 130 may be fixed to the inner case 11 by magnetic force.

For example, the sealing member 130 may include a magnetic body 131 configured to include a magnetic material. Correspondingly, the inner case 11 may include a metal plate 16 on which an attractive force acts with the magnetic body 131.

More specifically, the metal plate 16 may be provided on an inner surface of the inner case 11 facing the main body insulation 13. The metal plate 16 may be embedded by the main body insulation 13. More specifically, the metal plate 16 may be provided on an inner surface of the first flange 11a facing the main body insulation 13.

The metal plate 16 may extend along a periphery of the first flange 11a. The metal plate 16 may be formed to have a substantially flat plate shape. However, the shape of the metal plate 16 is not limited thereto.

The sealing member 130 may be fixed to the inner case 11 by an attractive force between the magnetic body 131 and the metal plate 16. Further, when a user inserts the freezing compartment case 100, even if the freezing compartment case 100 is not fully inserted, when the magnetic body 131 of the freezing compartment case 100 moves to a position adjacent to the metal plate 16, the freezing compartment case 100 may be completely inserted by the attractive force between the magnetic body 131 and the metal plate 16, and the second internal space 10c and the freezing compartment 22 may be sealed.

The first internal space 10b and the second internal space 10c may be in communication with the cooling chamber 50. Specifically, the refrigerator 1 may further include communication ports 14a and 14b that communicate between the second internal space 10c and the cooling chamber 50.

For example, the communication ports 14a and 14b may include a first communication port 14a provided to introduce cold air generated from the cooling chamber 50 into the second internal space 10c, and a second communication port 14b provided to return air that has undergone heat exchange in the second internal space 10c back to the cooling chamber 50. Air flow occurring between the second internal space 10c and the cooling chamber 50 through the communication ports 14a and 14b may be generated by the blower fan 72. That is, the refrigerator 1 according to an embodiment may be configured as an indirect cooling type refrigerator.

The communication ports 14a and 14b may be provided at the rear of the second internal space 10c. For example, the communication ports 14a and 14b may be formed at a front surface of the cold air supply duct 14. For example, the communication ports 14a and 14b may be formed to penetrate one side of the inner case 11.

The freezing compartment case 100 may cover the front of the communication ports 14a and 14b. Accordingly, unless the freezing compartment case 100 is completely separated from the second internal space 10c, the exterior of the communication ports 14a and 14b may not be exposed to the user, and thus the exterior quality of the product may be improved.

The freezing compartment case 100 may communicate with the cooling chamber 50. The freezing compartment case 100 may be provided to be supplied with cold air from the cooling chamber 50, with the communication with the cooling chamber 50. In other words, the freezing compartment 22 may communicate with the cooling chamber 50.

The freezing compartment case 100 may communicate with the second internal space 10c, and may communicate with the cooling chamber 50 via the second internal space 10c.

For example, the freezing compartment case 100 may include a cold air introduction port 112 formed to introduce cold air from the rear thereof. The cold air introduction port 112 may be provided at a rear surface of the case body 110. The cold air introduced into the second internal space 10c from the cooling chamber 50 may be introduced into the freezing compartment 22 through the cold air introduction port 112.

The cold air introduction port 112 may be formed at an upper portion of the freezing compartment case 100, and more specifically, at an upper portion of the case body 110. However, the present disclosure is not limited thereto, and a position of the cold air introduction port 112 may be variously provided.

The freezing compartment case 100 may include rail members 114, 115 an exhaust port 113 provided to discharge air that has undergone heat exchange in the freezing compartment 22. The exhaust port 113 may be provided in the case body 110. Air that has undergone heat exchange in the freezing compartment 22 may be discharged into the second internal space 10c through the exhaust port 113, and may be returned to the cooling chamber 50 through the second communication port 14b.

The exhaust port 113 may be formed at a lower portion of the freezing compartment case 100, and more specifically, at a lower portion of the case body 110. However, the present disclosure is not limited thereto, and a position of the exhaust port 113 may be variously provided.

The configuration in which the freezing compartment case 100 is provided to be supplied with cold air is not limited thereto, and the freezing compartment case 100 may be in communication with the second internal space 10c or the cooling chamber 50 through various configurations.

Alternatively, for example, the freezing compartment case 100 may not communicate with the second internal space 10c and the cooling chamber 50. Even if the second internal space 10c is supplied with cold air by being in communication with the cooling chamber 50, the freezing compartment case 100 may include the case body 110 made of a material having high thermal conductivity, and the case body 110 itself may be cooled by cold air in the second internal space 10c. Alternatively, for example, in a direct cooling type refrigerator, even if the freezing compartment 22 communicates with the second internal space 10c, the second internal space 10c may not communicate with the cooling chamber 50.

With the above configuration, the freezing compartment case 100 may be supplied with a suitable amount of cold air from the cooling chamber 50 to maintain a temperature of the freezing compartment 22. That is, the freezing compartment 22 may be provided in the second internal space 10c, which is separated from the first internal space 10b by the front surface portion 120 of the freezer compartment case 100, the sealing member 130, the partition wall 15, and the like, and may be supplied with cold air through a supply flow path that is distinguished from a supply flow path of the cold air introduced into the first internal space 10b.

An ice tray 140 for producing ice may be provided in freezing compartment case 100. The freezing compartment case 100 may include a tray supporter 150 for supporting the ice tray 140. The tray supporter 150 may be formed to accommodate the ice tray 140 and may be supported by the case body 110.

The case body 110 may include an ice tray guide 117. The ice tray guide 117 may support the tray supporter 150. The ice tray guide 117 may guide the tray supporter 150 to move in a forward-backward direction.

However, the configurations of the ice tray 140, the tray supporter 150, the ice tray guide 117, and the like are not limited to those described above, and may be variously configured. An ice-making system for producing ice in the freezing compartment 22 may be variously provided.

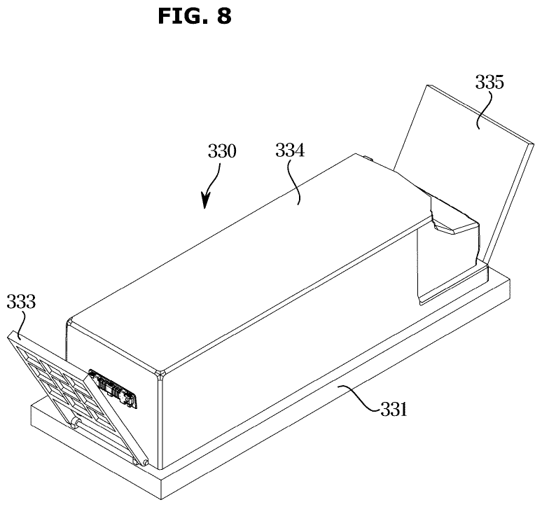

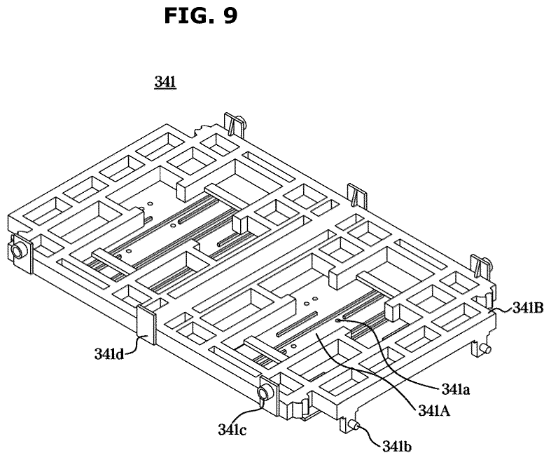

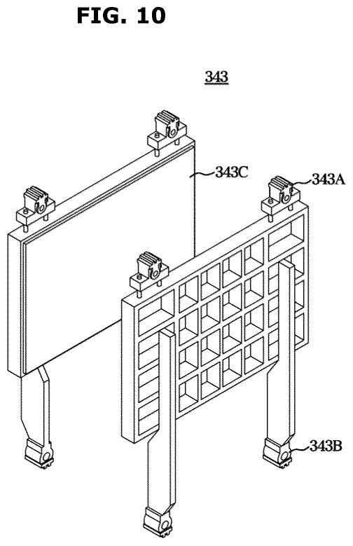

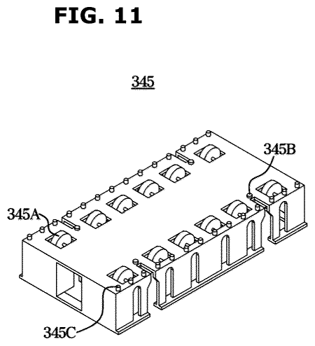

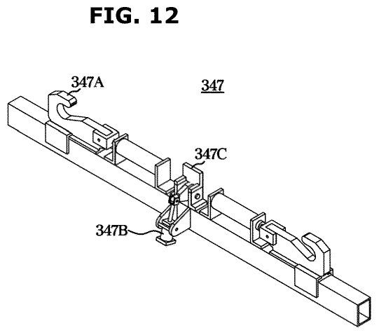

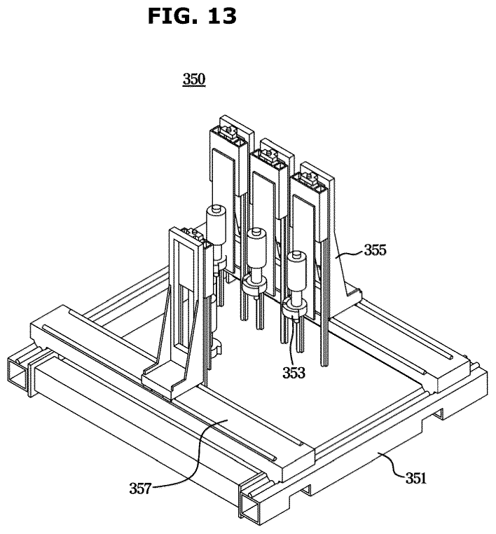

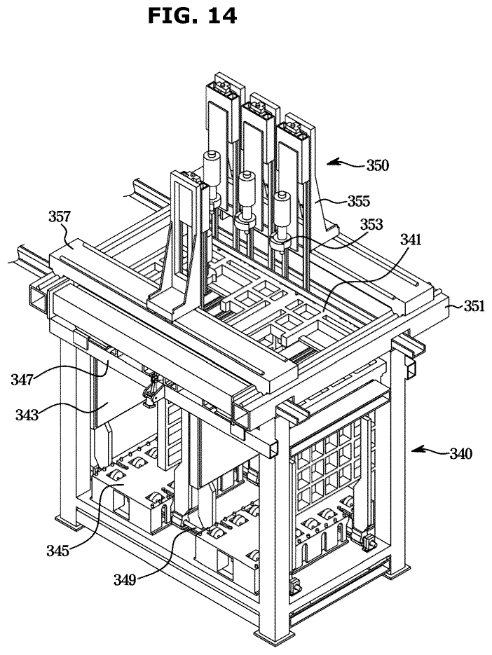

FIG. 7 is a perspective view of a refrigerator foaming apparatus according to an embodiment of the present disclosure. FIG. 8 is a view illustrating a foaming mold of the refrigerator foaming apparatus according to an embodiment. FIG. 9 is a view illustrating an upper fixture provided in a fixture of the refrigerator foaming apparatus according to an embodiment. FIG. 10 is a view illustrating a supporter provided in a fixture of the refrigerator foaming apparatus according to an embodiment. FIG. 11 is a view illustrating a lower fixture provided in a fixture of the refrigerator foaming apparatus according to an embodiment. FIG. 12 is a view illustrating a height adjuster provided in a fixture of the refrigerator foaming apparatus according to an embodiment. FIG. 13 is a view illustrating a foaming agent injection device of the refrigerator foaming apparatus according to an embodiment. FIG. 14 is a view illustrating a state in which the foaming agent injection device of the refrigerator foaming apparatus has moved to the fixture according to an embodiment.

Hereinafter, a structure and foaming process of the refrigerator foaming apparatus 300 that inputs a foaming agent into the refrigerator cabinet C and performs foaming will be described in detail. The refrigerator cabinet C may refer to the inner case 11 of the refrigerator. With reference to FIGS. 7 to 14, the refrigerator foaming apparatus 300 may be a refrigerator cabinet foaming apparatus 300 for foaming the refrigerator cabinet C. The refrigerator cabinet foaming apparatus 300 may include a transfer device 310 for supplying or discharging the refrigerator cabinet C. The refrigerator cabinet foaming apparatus 300 may include a loading device 320 for loading or unloading the refrigerator cabinet C transferred by the transfer device 310. The refrigerator cabinet foaming apparatus 300 may include a foaming mold 330 to which the refrigerator cabinet C is coupled by the loading device 320. The refrigerator cabinet foaming apparatus 300 may include a fixture 340 into which the foaming mold 330 and the refrigerator cabinet C that are coupled with each other are input in a coupled state. The refrigerator cabinet foaming apparatus 300 may include a foaming agent injection device 350 for injecting a foaming agent into a combination MC of the foaming mold 330 and the refrigerator cabinet C input into the fixture 340. The refrigerator cabinet foaming apparatus 300 may include a model changing device 360 for changing the model of foaming mold 330 so that the foaming mold 330 suitable for the model of the refrigerator cabinet C is supplied.

The transfer device 310 may include a supplier 311 to which the refrigerator cabinet C is supplied, a discharger 313 from which the refrigerator cabinet C is discharged, and a conveyor 315 enabling movement of the refrigerator cabinet C.

The refrigerator cabinet C supplied to the supplier 311 of the transfer device 310 may be transferred to the loading device 320 along the conveyor 315, and the refrigerator cabinet C transferred to the loading device 320 may be loaded by a loader 321 and coupled with the foaming mold 330.

As illustrated in FIG. 8, the foaming mold 330 may be disposed to be surrounded by a lower plate 331, a front surface support plate 333, and a rear surface support plate 335.

As illustrated in FIG. 7 and FIG. 14, the fixture 340 may include an upper fixture 341, a supporter 343, a lower fixture 345, a height adjuster 347, and a guide rail 349.

As illustrated in FIG. 9, the upper fixture 341, which brings an upper portion of the input foaming mold and refrigerator cabinet combination MC into close contact, may include a base 341A and an upper plate 341B.

The base 341A, which is in close contact with the upper portion of the foaming mold and refrigerator cabinet combination MC, may be provided with a foaming agent injection port 341a, which serves as a passage for injecting a foaming agent into the foaming mold and refrigerator cabinet combination MC through the foaming agent injection device 350.

The upper plate 341B may include a coupling pin 341b, a cam roller 341c, and a toggle 341d.

The coupling pin 341b may be coupled to an upper coupling portion 343A of the supporter 343, which will be described below, to allow left-right movement of the supporter 343, and the cam roller 341c may be coupled to a cam guide 347A of the height adjuster 347, which will be described below, to allow the upper fixture 341 to descend or ascend through friction between the cam roller 341c and the cam guide 347A.

The toggle 341d may be configured to be connectable to a toggle plate 347C of the height adjuster 347, which will be described below, and when the toggle 341d and the toggle plate 347C are connected, the upper plate 341B may be fixed, and when the toggle 341d and the toggle plate 347C are separated, the upper plate 341B may ascend or descend.

As illustrated in FIG. 10, the supporter 343 may include an upper coupling portion 343A, a lower coupling portion 343B, and a support plate 343C.

The upper coupling portion 343A may be coupled to a coupling pin 341b of the upper plate 341B, and the lower coupling portion 343B may be coupled to the guide rail 349 positioned at a lower portion of the fixture 340.

The upper coupling portion 343A and the lower coupling portion 343B of the supporter 343 may be respectively coupled to the coupling pin 341b and the guide rail 349, so that the supporter 343 may be movable left and right.

Through such left and right movement of the supporter 343, the support plate 343C may support left and right sides of the foaming mold and refrigerator cabinet combination MC, and may fix the foaming mold and refrigerator cabinet combination MC.

As illustrated in FIG. 14, four support plates 343C may be provided in a single fixture 340, so that two foaming mold and refrigerator cabinet combinations MC may be simultaneously input into the single fixture 340, and a foaming agent may be injected.

As illustrated in FIG. 11, the lower fixture 345 may include a driving roller 345A, a positioning pin 345B, and a guide roller 345C.

The driving roller 345A may be provided to move the foaming mold and refrigerator cabinet combination MC to be input into the fixture 340, and the foaming mold and refrigerator cabinet combination MC input into the fixture 340 may be input without deviating to the outside by the guide roller 345C.

The foaming mold and refrigerator cabinet combination MC may be input into the fixture 340, and then guided to a correct position and seated by the positioning pin 345B.

As illustrated in FIG. 14, the height adjuster 347 may include a cam guide 347A, a toggle switch 347B, and a toggle plate 347C.

The height adjuster 347 may adjust the height of the upper fixture 341.

When the foaming mold and refrigerator cabinet combination MC is input into the fixture 340, the toggle switch 347B may be turned on, and the toggle plate 347C may be separated from the toggle 341d of the upper fixture 341.

When the toggle plate 347C and the toggle 341d are separated, the upper fixture 341 may be allowed to move, and the upper fixture 341 may descend through friction between the cam roller 341c of the upper fixture 341 and the cam guide 347A of the height adjuster 347.

When the upper fixture 341 descends and the base 341A of the upper fixture 341 comes into close contact with an upper portion of the foaming mold and refrigerator cabinet combination MC input into the fixture 340, the toggle switch 347B may be turned off, and the toggle plate 347C and the toggle 341d of the upper fixture 341 may be connected.

When the toggle plate 347C and the toggle 341d are connected, the upper fixture 341 may be fixed, and after the upper fixture 341 is fixed, a foaming agent may be injected into the foaming mold and refrigerator cabinet combination MC by the foaming agent injection device 350.

After the injection of the foaming agent is completed and the curing time of the foaming agent is completed, the toggle switch 347B may be turned on, and the toggle plate 347C and the toggle 341d may be separated.

When the toggle plate 347C and the toggle 341d are separated, the upper fixture 341 may be allowed to move, and the upper fixture 341 may ascend through friction between the cam roller 341c of the upper fixture 341 and the cam guide 347A of the height adjuster 347.

When the ascent of the upper fixture 341 is completed, the toggle switch 347B may be turned off, the toggle plate 347C and the toggle 341d may be connected, and the upper fixture 341 may be fixed.

As illustrated in FIG. 13, the foaming agent injection device 350 may include a foaming agent injection device guider 351, a foaming agent injection head 353, a foaming agent injection head fixing portion 355, and a foaming agent injection head guider 357.

When the foaming mold and refrigerator cabinet combination MC is input into the fixture 340 and the base 341A of the upper fixture 341 comes into close contact with an upper portion of the foaming mold and refrigerator cabinet combination MC, the foaming agent injection device 350 may be moved to the fixture 340 by the foaming agent injection device guider 351.

When the foaming agent injection device 350 is moved to an upper portion of the fixture 340, each foaming agent injection head fixing portion 355 may be moved by the foaming agent injection head guider 357.

When each foaming agent injection head fixing portion 355 is moved to a position where the foaming agent injection port 341a formed in the base 341A of the upper fixture 341 is positioned, the foaming agent injection head 353 fixed to each foaming agent injection head fixing portion 355 may descend and be input into the foaming agent injection port 341a.

When the injection of the foaming agent is completed, the foaming agent injection head 353 may ascend, and when the ascent of the foaming agent injection head 353 is completed, the foaming agent injection device 350 may be moved to a next fixture 340 by the foaming agent injection device guider 351.

Although four foaming agent injection heads 353 are illustrated in the drawings, the number of the foaming agent injection heads 353 may be configured to be four or less or four or more according to a model of the refrigerator cabinet C.

By providing a plurality of foaming agent injection heads 353 and injecting the foaming agent at multiple positions simultaneously, a curing time of the foaming agent may be shortened.

As illustrated in FIG. 7, the refrigerator cabinet foaming apparatus 300 may include the model changing device 360. The model changing device 360 may be a device for directly supplying a corresponding foaming mold 330 according to a model of the refrigerator cabinet C.

According to the model of the supplied refrigerator cabinet C, the model changing device 360 may supply the corresponding foaming mold 330 immediately, thereby reducing a replacement time of the foaming mold 330 and improving productivity.

Next, the refrigerator cabinet foaming process will be described with reference to FIGS. 7 to 14.

First, when the refrigerator cabinet C is supplied through the supplier 311, the refrigerator cabinet C may be transferred to the loading device 320 along the conveyor 315.

The refrigerator cabinet C transferred to the loading device 320 may be loaded by a loader 321 included in the loading device 320, and may be moved to a position where the foaming mold 330 is positioned.

When the loader 321 is moved to the position where the foaming mold 330 is positioned, the refrigerator cabinet C loaded on the loader 321 may be unloaded and coupled with the foaming mold 330.

When the refrigerator cabinet C in a coupled state with the foaming mold 330 is moved to a distribution cart DC, the distribution cart DC may be moved to an empty fixture 340 to input the foaming mold and refrigerator cabinet combination MC.

When the distribution cart DC is moved to the empty fixture 340, the foaming mold and refrigerator cabinet combination MC may be input into the fixture 340.

The foaming mold and refrigerator cabinet combination MC input into the fixture 340 may be moved by the driving roller 345A of the lower fixture 345, and may be guided to not deviate to the outside by the guide roller 345C, and be input into the fixture 340.

The foaming mold and refrigerator cabinet combination MC input into the fixture 340 may be guided to a correct position and seated by the positioning pin 345B.

When the foaming mold and refrigerator cabinet combination MC is input into the fixture 340, the supporter 343 may be moved left and right, and left and right surfaces of the foaming mold and refrigerator cabinet combination MC may be supported by the support plate 343C.

When the left and right surfaces of the foaming mold and refrigerator cabinet combination MC are supported by the support plate 343C of the supporter 343, the toggle switch 347B of the height adjuster 347 may be turned on, and the toggle plate 347C of the height adjuster 347 and the toggle 341d of the upper fixture 341 may be separated.

When the toggle plate 347C and the toggle 341d are separated, the upper fixture 341 may be enabled to move, and the upper fixture 341 enabled to move may descend.

The upper fixture 341 may descend due to friction between the cam roller 341c of the upper fixture 341 and the cam guide 347A of the height adjuster 347, such that the base 341A of the upper fixture 341 comes into close contact with an upper portion of the foaming mold and refrigerator cabinet combination MC.

When the base 341A comes into close contact with the upper portion of the foaming mold and refrigerator cabinet combination MC, the toggle switch 347B of the height adjuster 347 may be turned off, and the toggle plate 347C and the toggle 341d may be separated, thereby fixing the upper fixture 341.

When the upper fixture 341 is fixed in a state of being in close contact with the upper portion of the foaming mold and refrigerator cabinet combination MC, the foaming agent injection device 350 may be moved.

The foaming agent injection device 350 may be moved to the fixture 340 into which the foaming mold and refrigerator cabinet combination MC is input by the foaming agent injection device guider 351.

When the foaming agent injection device 350 is moved to an upper portion of the fixture 340, the foaming agent injection head fixing portion 355 may be moved to a position where the foaming agent injection port 341a formed in the base 341A of the upper fixture 341 is formed by the foaming agent injection head guider 357.

When the foaming agent injection head fixing portion 355 is moved to the position where the foaming agent injection port 341a is formed, the foaming agent injection head 353 fixed to the foaming agent injection head fixing portion 355 may descend.

When the foaming agent injection head 353 descends and is input into the foaming agent injection port 341a, the foaming agent may be injected.

When the injection of the foaming agent is completed, the foaming agent injection head 353 may ascend, and when the ascent of the foaming agent injection head 353 is completed, the foaming agent injection device 350 may be moved to a next fixture 340 by the foaming agent injection device guider 351.

After the injection of the foaming agent is completed and the curing time of the foaming agent is completed, the toggle switch 347B provided in the height adjuster 347 may be turned on, and the toggle plate 347C of the height adjuster 347 and the toggle 341d of the upper fixture 341 may be separated.

When the toggle plate 347C and the toggle 341d are separated, the upper fixture 341 may ascend through friction between the cam guide 347A of the height adjuster 347 and the cam roller 341c of the upper fixture 341, and may be separated from the foaming mold and refrigerator cabinet combination MC.

When the upper fixture 341 ascends after being separated from the foaming mold and refrigerator cabinet combination MC, the supporter 343 may be moved left and right, and the support plate 343C may be separated from the foaming mold and refrigerator cabinet combination MC.

When an upper portion and left and right surfaces of the foaming mold and refrigerator cabinet combination MC are all separated from the fixture 340, the foaming mold and refrigerator cabinet combination MC may be moved by the driving roller 345A of the lower fixture 345 and discharged to the distribution cart DC.

The foaming mold and refrigerator cabinet combination MC discharged to the distribution cart DC may be moved to the loading device 320.

The foaming mold and refrigerator cabinet combination MC moved to the loading device 320 may be loaded in a state in which the refrigerator cabinet C is separated from the foaming mold 330, by the loader 321, and may be moved to the transfer device 310.

The refrigerator cabinet C transferred to the transfer device 310 may be transferred to the discharger 313 along the conveyor 315, and the refrigerator cabinet C discharged through the discharger 313 may be input to a next process.

In the process as described above, when a model of the supplied refrigerator cabinet C is changed, the foaming mold 330 corresponding thereto may be directly supplied by the model changing device 360, and the same process as above may be performed.

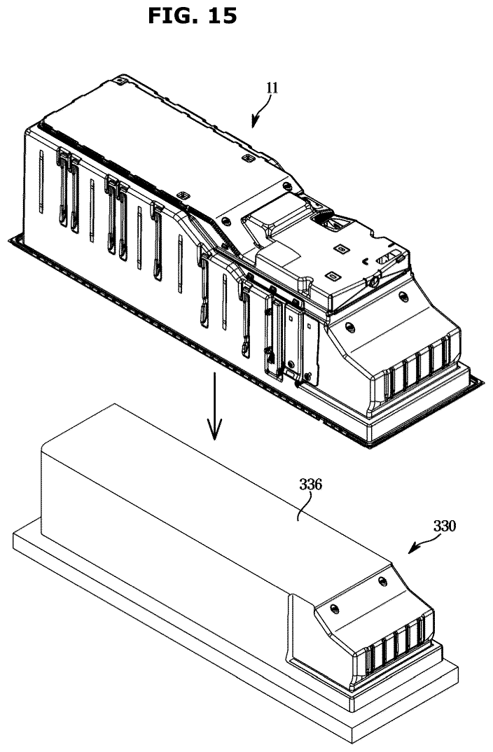

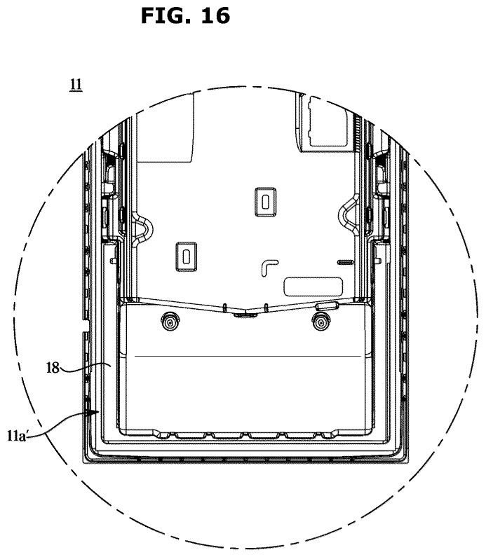

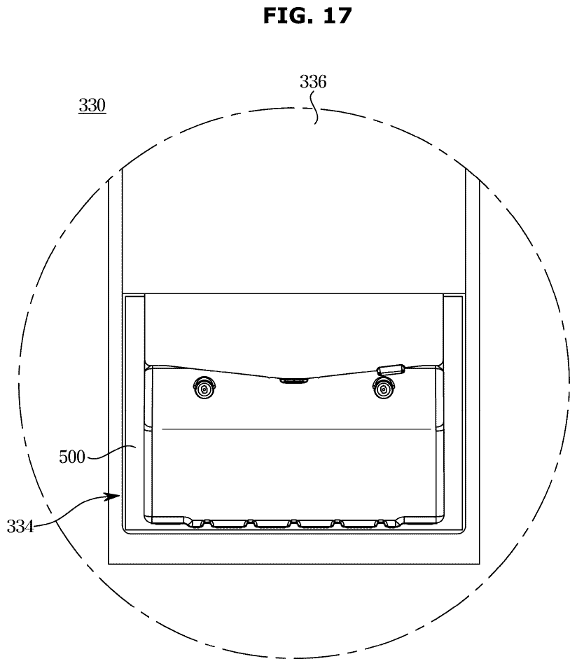

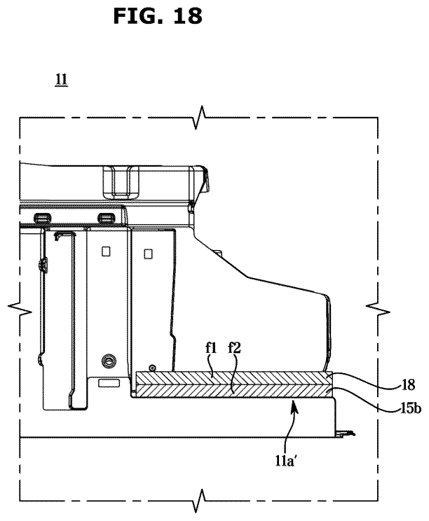

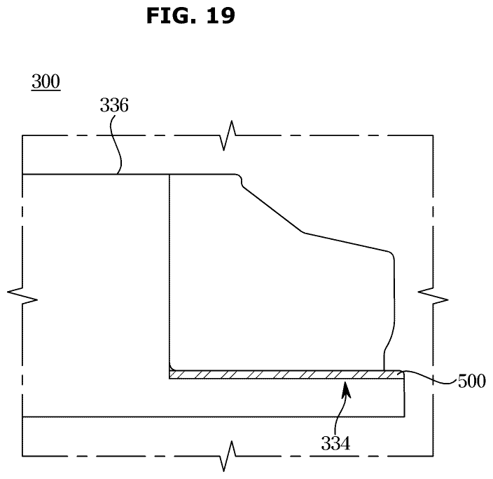

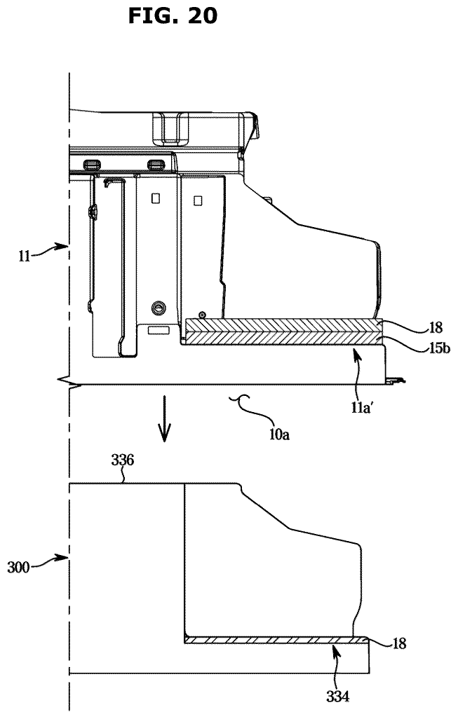

FIG. 15 is a view illustrating a state in which a refrigerator cabinet and a foaming mold are separated from each other according to an embodiment. FIG. 16 is a view illustrating the refrigerator cabinet of FIG. 15 from a different angle. FIG. 17 is a view illustrating the foaming mold of FIG. 15 from a different angle. FIG. 18 is a side cross-sectional view illustrating a metal plate and a heater in a refrigerator cabinet according to an embodiment. FIG. 19 is a side cross-sectional view illustrating a magnet in a foaming mold according to an embodiment. FIG. 20 is a view illustrating a state in which a refrigerator cabinet is seated in a foaming mold according to an embodiment.

With reference to FIGS. 15 to 20, the refrigerator cabinet C may be seated on the foaming mold 330 for foaming. More specifically, the inner case 11 of the refrigerator cabinet C may be seated on the foaming mold 330. As described above, after the refrigerator cabinet C is seated on the foaming mold 330, foaming may be performed by the refrigerator foaming apparatus 300.

The inner case 11 may be seated on a seating surface 336 of the foaming mold 330. The storage compartment opening 10a of the refrigerator cabinet C may be disposed to face the seating surface, and the foaming mold 330 may be inserted into the storage compartment opening 10a side of the refrigerator cabinet C and may seat the refrigerator cabinet C.

The refrigerator cabinet C may include a first flange 11a′ provided along an edge of the storage compartment opening 10a. More specifically, the first flange 11a′ may be provided along an edge of the second internal space.

The foaming mold 330 may include a second flange 334 formed to correspond to the first flange 11a′. When the first flange 11a′ of the refrigerator cabinet C is seated on the foaming mold 330, it may be disposed to face the second flange 334. That is, one surface of the first flange 11a′ may be disposed to be positioned corresponding to the second flange 334.

On the other surface of the first flange 11a′, a metal plate 15b to which a heater 18 is attached may be disposed. The metal plate 15b may be provided to extend along the other surface of the first flange 11a′. The metal plate 15b may be disposed in the refrigerator cabinet C so as to be in contact with the other surface of the first flange 11a′.

The heater 18 may be attached to the metal plate 15b through an adhesive or a double-sided tape or the like. The heater 18 may be attached to a surface f1 different from a surface f2 of the metal plate 15b which is in contact with the first flange 11a′ of the inner case 11 of the refrigerator cabinet C. More specifically, the heater 18 may be attached to the metal plate 15b such that the metal plate 15b is disposed between the heater 18 and the first flange 11a′.

The foaming mold 330 may include a magnet 500. The magnet 500 may apply magnetic force to a metal object to form attractive force. For example, the magnet 500 may apply magnetic force to the metal plate 15b disposed in the refrigerator cabinet C. The magnet 500 may be provided on the second flange 334. Because the first flange 11a′ and the second flange 334 are disposed to correspond to each other, the metal plate 15b and the magnet 500 may also be disposed to correspond to each other.

The magnet 500 may include a plate-shaped magnet 500 provided to extend along the second flange 334. The magnet 500 may be provided to cover the entire second flange 334. In case where the magnet 500 includes the plate-shaped magnet 500, a shape of the heater 18 may be provided to include a shape of the magnet 500. However, the present disclosure is not limited thereto, and the second flange 334 may be formed of the magnet 500. In addition, the magnet 500 may be provided as a plurality of magnets 400 and may be disposed to be spaced apart from each other along the second flange 334. In case where the magnet 500 is provided as a plurality of magnets 400, a shape of the magnets 400 may be circular, but the shape is not limited thereto. The plurality of magnets 400 may be provided to form a portion of the second flange 334.

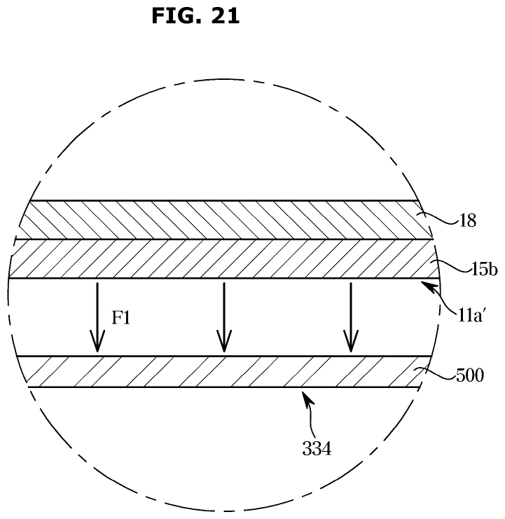

FIG. 21 is a view illustrating a state in which a metal plate is in close contact with the other surface of a first flange by a magnet according to an embodiment.

With reference to FIG. 21, when the inner case 11 of the refrigerator cabinet Cis seated on the foaming mold 330, the second flange 334 may be disposed to face one surface of the first flange 11a′. When the inner case 11 of the refrigerator cabinet C is seated on the foaming mold 330, the magnet 500 provided on the second flange 334 may apply magnetic force to the metal plate 15b provided on the other surface of the first flange 11a′, and may pull the metal plate 15b.

When the magnet 500 pulls the metal plate 15b, the metal plate 15b may strongly come into close contact with the other surface of the first flange 11a′. Because the heater 18 is coupled to the metal plate 15b by an adhesive or the like, the heater 18 may move together with the close contact of the metal plate 15b, and may come into close contact with the other surface of the first flange 11a′.

Because the metal plate 15b is in close contact with the other surface of the first flange 11a′, even when it comes into contact with the foaming agent in a liquid state, the foaming agent may not permeate between the other surface of the first flange 11a′ and the metal plate 15b. Therefore, the metal plate 15b may be fixed while maintaining its original position, and performance of the heater 18 may also be maintained. Thereafter, when the foaming agent is cured, the heater 18 and the metal plate 15b may be pressed by the cured foaming agent and may be permanently fixed in a state of being in close contact with the other surface of the first flange 11a′.

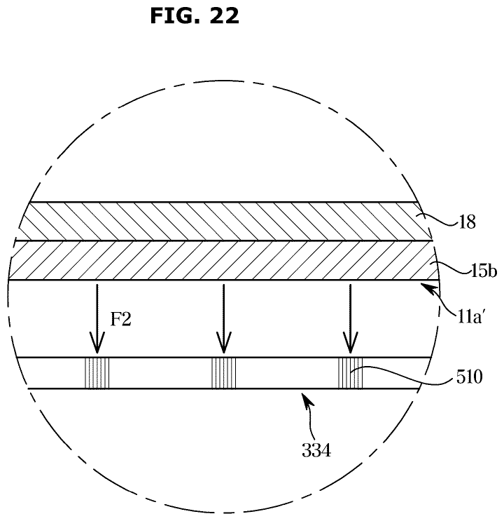

FIG. 22 is a view illustrating a state in which a metal plate is in close contact with the other surface of a first flange by a plurality of magnets according to an embodiment.

With reference to FIG. 22, the magnet 510 may be provided as a plurality. When the magnet 510 is provided as a plurality and disposed to be spaced apart from each other on the other surface of a first flange 11a′, the plurality of magnets 510 may each apply magnetic force to the metal plate 15b. When the plurality of magnets 510 pull the metal plate 15b, the metal plate 15b may strongly come into close contact with the other surface of the first flange 11a′. Because the heater 18 is coupled to the metal plate 15b by an adhesive or the like, the heater 18 may move together with the close contact of the metal plate 15b, and may come into close contact with the other surface of the first flange 11a′. Therefore, the foaming agent in a liquid state may not permeate between the metal plate 15b and the other surface of the first flange 11a′, so that the metal plate 15b may be fixed while maintaining its original position, and performance of the heater 18 may also be maintained.

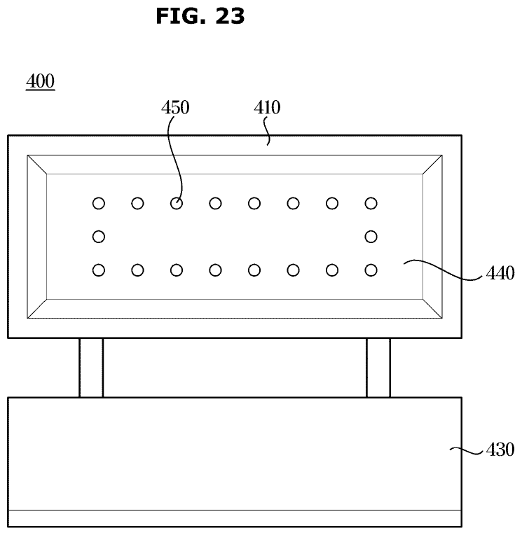

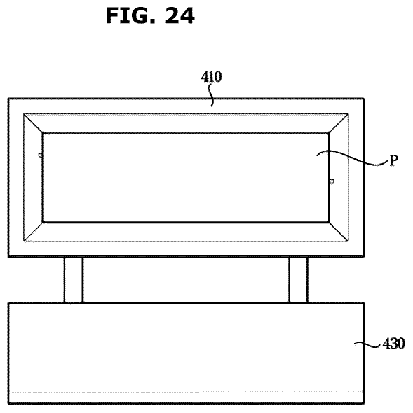

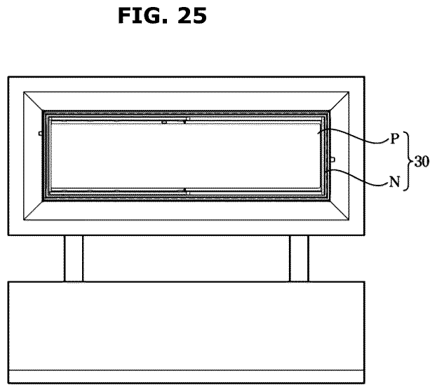

FIG. 23 is a view illustrating a refrigerator foaming apparatus for foaming a refrigerator door according to an embodiment. FIG. 24 is a view illustrating a state in which a door plate (metal plate) is attached by a magnet of the refrigerator foaming apparatus of FIG. 23. FIG. 25 is a view illustrating a state in which a panel is attached to the refrigerator foaming apparatus of FIG. 24.

With reference to FIGS. 23 to 25, a refrigerator foaming apparatus 400 may include a device for foaming the door 30 of the refrigerator. The refrigerator foaming apparatus 400 may be a refrigerator foaming apparatus 400 for foaming a refrigerator component including a metal plate P, and may include a foaming mold 410 which is provided to come into contact with one surface of the component and to seat the component. More specifically, the refrigerator foaming apparatus 400 may include the foaming mold 410 on which a plate P that constitutes the refrigerator door 30 is seated. Therefore, the component may be an element constituting the refrigerator door 30.

The plate P may be made of a metal plate (hereinafter referred to as the metal plate P). The foaming mold 410 may include a magnet 450 provided to apply magnetic force to the metal plate P of the seated component toward the foaming mold 410 side. The magnet 450 may be disposed to form a closed area along an edge of the foaming mold 410. The magnet 450 may be disposed to correspond to an outer periphery of the plate P.

The plate P may be attached to the foaming mold 410 by the magnet 450 of the foaming mold 410. More specifically, the plate P may be attached to a foaming surface 440 of the foaming mold 410. Because the magnet 450 is disposed along the outer periphery of the plate P, the plate P may be disposed corresponding to a form in which the magnet 450 is disposed. That is, the disposition of the magnet 450 may serve as a guide for determining the position at which the plate P is disposed on the foaming mold 410. The plate P may be provided to be in close contact with the foaming mold 410 side by the magnet 450.

After the plate P is seated on the foaming mold 410, a panel N may be coupled to the plate P. The panel N may form one surface of the refrigerator door 30 by being coupled with the plate P.

The refrigerator foaming apparatus 400 for foaming the refrigerator door 30 may include a base mold 430. After the plate P and the panel N are seated on the foaming mold 410, the foaming mold 410 and the base mold 430 may be coupled to each other. After the foaming mold 410 and the base mold 430 are coupled, a foaming agent may be sprayed, and the refrigerator door 30 may be foamed.

According to an embodiment, a refrigerator foaming apparatus 300 for foaming a refrigerator cabinet C including an inner case 11 in which a first flange 11a′ is provided along an edge of a storage compartment opening 10a, and a metal plate 15b to which a heater 18 is attached is disposed on the other surface of the first flange 11a′, includes a foaming mold 330 which is inserted into the storage compartment opening 10a side to seat the inner case 11, and which includes a second flange 334 provided to face one surface of the first flange 11a′. The foaming mold 330 includes a magnet 500 provided to bring the metal plate 15b, disposed in the seated inner case, into close contact with the other surface of the first flange 11a′. The magnet 500 is provided on the second flange 334 so as to be positioned corresponding to the metal plate 15b disposed on the first flange 11a′ when the foaming mold 330 is inserted into the storage compartment opening 10a side.

The heater 18 attached to the metal plate 15b may be attached to a surface f1 different from a surface f2 of the metal plate 15b, the surface f2 being in contact with the first flange 11a′ of the inner case.

The heater 18 may be attached to the metal plate 15b such that the metal plate 15b is disposed between the heater 18 and the first flange 11a′.

The magnet 500 may include a plate-shaped magnet 500 provided to extend along the second flange 334.

The heater 18 may be provided to include a shape corresponding to the magnet 500.

The magnet 500 may be provided to form the second flange 334.

The magnet 500 may include a plurality of magnets 400. The plurality of magnets 400 may be disposed to be spaced apart from each other along the second flange 334.

Each of the plurality of magnets 510 may be provided to bring the metal plate 15b into close contact with the first flange 11a′.

The plurality of magnets 510 may be provided to form a portion of the second flange 334.

The plurality of magnets 510 may include circular magnets.

According to an embodiment, a refrigerator foaming apparatus 300 for foaming a refrigerator cabinet C including an inner case 11 in which a first flange 11a′ is provided along an edge of a storage compartment opening 10a, and a metal plate 15b to which a heater 18 is attached is disposed on the other surface of the first flange 11a′, may include a transfer device 310 that transfers the cabinet C of the refrigerator to a standby point. The refrigerator foaming apparatus 300 may include a loading device 320 that couples the cabinet C, transferred to the standby point, to the foaming mold 330 to form a combination MC. The refrigerator foaming apparatus 300 may include a fixture 340 that accommodates the combination MC of the cabinet C and the foaming mold 330. The refrigerator foaming apparatus 300 may include a foaming agent injection device 350 for injecting a foaming agent into the combination accommodated in the fixture 340. The foaming mold 330 is inserted into the storage compartment opening side and seats the inner case 11. The foaming mold 330 includes a second flange 334 provided to face one surface of the first flange 11a′. The foaming mold 330 includes a magnet 500 provided to bring a metal plate 15b, which is disposed in the seated inner case 11, into close contact with the other surface of the first flange 11a′. The magnet 500 may be provided on the second flange 334 so as to be positioned corresponding to the metal plate 15b disposed on the first flange 11a′ when the foaming mold 330 is inserted into the storage compartment opening 10a side.

The heater 18 attached to the metal plate 15b may be attached to a surface f1 different from a surface f2 of the metal plate 15b, the surface f2 being in contact with the first flange 11a′ of the inner case.

The heater 18 may be attached to the metal plate 15b such that the metal plate 15b is disposed between the heater 18 and the first flange 11a′.

The magnet 500 may include a plate-shaped magnet 500 provided to extend along the second flange 334.

The heater 18 may be provided to include a shape corresponding to the magnet 500.

The magnet 500 may be provided to form the second flange 334.

The magnet 500 may include a plurality of magnets 400. The plurality of magnets 400 may be disposed to be spaced apart from each other along the second flange 334.

The plurality of magnets 400 may be provided to configure a portion of the second flange 334.

A refrigerator foaming apparatus 400 for foaming a refrigerator component 30 including a metal plate P according to an embodiment may include a foaming mold 410 which is provided to be in contact with one surface of the component 30 and to seat the component 30. The foaming mold 410 may include a magnet 450 provided to apply magnetic force to the metal plate P of the seated component 30 toward the foaming mold 410 side. The magnet 450 is provided along a portion of an edge side of the foaming mold 410 to bring the component 30 into close contact with the foaming mold 410 side.

According to the spirit of the present disclosure, because the foaming mold includes a magnet, when the cabinet is seated on the foaming mold, the metal plate may be brought into close contact with the cabinet by magnetic force.

According to the spirit of the present disclosure, the metal plate is brought into close contact with the cabinet, so that infiltration of a foaming agent in a liquid state between the metal plate and the cabinet may be prevented, and performance of a heater may be maintained.

According to the spirit of the present disclosure, the position of the metal plate may be stably fixed by the magnet of the foaming mold.

According to the spirit of the present disclosure, because the metal plate is fixed by the magnet, it may not be necessary to use a double-sided tape or the like, thereby removing unnecessary materials and processes.

The effects obtained by the present disclosure are not limited to the aforementioned effects, and other effects, which are not mentioned above, will be clearly understood by those skilled in the art from the following description.

The above describes and illustrates specific embodiments. However, the present disclosure is not limited to the specific embodiments described above, and a person skilled in the art to which the present disclosure pertains would be able to make various modifications without departing from the scope of the technical spirit of the present disclosure as set forth in the following claims.

1. A refrigerator foaming apparatus for foaming a refrigerator cabinet, the refrigerator foaming apparatus comprising:
a foaming mold insertable into a side of a storage compartment through an opening of the storage compartment to seat an inner case of the refrigerator cabinet where an edge of the inner case includes a first flange, the foaming mold including a second flange which faces one surface of the first flange while the foaming mold is inserted into the side of the storage compartment,
wherein the foaming mold includes a magnet configured to bring a metal plate of the refrigerator cabinet on another surface of the first flange, to which a heater is attached and which is disposed in the inner case that is seated, into close contact with the other surface of the first flange, and
the magnet is provided on the second flange so as to be positioned corresponding to the metal plate disposed on the first flange based on the foaming mold being inserted into the side of the opening of the storage compartment.

2. The refrigerator foaming apparatus of claim 1, wherein
the heater attached to the metal plate is attached to a surface of the metal plate that is different from a surface of the metal plate being brought in contact with the first flange of the inner case.

3. The refrigerator foaming apparatus of claim 2, wherein
the heater is attached to the metal plate such that the metal plate is disposed between the heater and the first flange.

4. The refrigerator foaming apparatus of claim 1, wherein
the magnet includes a plate-shaped magnet provided to extend along the second flange.

5. The refrigerator foaming apparatus of claim 4, wherein
the heater is provided to include a shape corresponding to the magnet.

6. The refrigerator foaming apparatus of claim 4, wherein
the magnet is provided to form the second flange.

7. The refrigerator foaming apparatus of claim 1, wherein
the magnet is among a plurality of magnets, and
the plurality of magnets are disposed to be spaced apart from each other along the second flange.

8. The refrigerator foaming apparatus of claim 7, wherein
each of the plurality of magnets is provided to bring the metal plate into close contact with the first flange.

9. The refrigerator foaming apparatus of claim 7, wherein
the plurality of magnets are provided to form a portion of the second flange.

10. The refrigerator foaming apparatus of claim 7, wherein
the plurality of magnets include circular magnets.
